(19) United States
(12) Patent Application Publication
(10) Pub. No.: US 2008/0220275 A1
(43) Pub. Date: Sep. 11, 2008

(54) Water-based one package coat and multilayer coating film-forming method

(76) Inventors: Takashi Noguchi, Hiratsuka-shi (JP); Takato Adachi, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/073,519

(22) Filed: Mar. 6, 2008

(30) Foreign Application Priority Data
Mar. 8, 2007 (JP) 2007-58443

(51) Int. Cl. C08K 5/17; B32B 27/00; B05D 3/00

(52) U.S. Cl. 428/500; 524/500; 524/186; 427/407.1; 427/385.5

(57) ABSTRACT

The invention provides water-based one package coat comprising acrylic resin having specific long chain primary hydroxyl-containing side chains as crosslinking functional groups and a solubility parameter of 9.30-11.20, and blocked polyisocyanate compound having a solubility parameter of 9.00-11.50, the difference ΔSP between the solubility parameter (SP1) of the acrylic resin and the solubility parameter (SP2) of the blocked polyisocyanate compound (ΔSP=(SP1)−(SP2)) being within a range of from −0.80 to 1.50.

### TECHNICAL FIELD

This invention relates to water-based one package coat excelling in curability, coating film performance, coated surface smoothness and aqueous dispersion stability and method of forming multilayer coating film using the water-based one package coat.

### BACKGROUND ART

Recently, environmental problems on global scale are gathering keen attention. In the automotive industry also working on countermeasures to environmental issue in the manufacturing steps is positively advanced. Manufacturing steps of automotives give rise to such problems as global warming, generation of industrial waste and discharge of volatile organic compounds (VOC). In particular, most of the VOC is discharged during the coating step and therefore VOC reduction there is in pressing need.

Outer panel portion of automobile bodies are normally coated with multilayer coating film formed of undercoat film of cationic electrocoating, intermediate coat film and top coat film, for imparting corrosion resistance and for aesthetic purpose. With the view to reduce VOC discharge, use of water-based paints for intermediate and top coatings is promoted. For example, as clear paint to be used as the top coat, water-based two package clear paint composition containing polyisocyanate compound as the crosslinking agent is under consideration, from the viewpoints of coating film performance and coated surface smoothness. For instance, a two-component paint composition characterized by presence of a polyisocyanate compound as emulsified in specific polyol component was disclosed (see, e.g., JP Hei 8 (1996)-32851B). This composition, however, requires mixing of the polyisocyanate compound as crosslinking agent immediately before use of the paint, being a two package coat, and is subject to restrictions by apparatus and manner of use. Still another problem is that the coating film formed from the paint composition shows insufficient performance in, e.g. weatherability.

On the other hand, usually blocked polyisocyanate compound is used in one package coat containing polyisocyanate compound as the crosslinking agent, and because blocked polyisocyanate compound is generally hydrophobic, it tends to show insufficient dispersing stability in water-based paint. Because it is difficult to uniformly disperse blocked polyisocyanate compound in the paint, for example, JP 2004-515571A proposed to make it water-dispersible with use of a specific polyol containing urethane groups. Whereas, it requires a large amount of the polyurethane resin for obtaining stable dispersing stability and hence satisfactory curability cannot be obtained, which leads to insufficient physical property of the coating film.

JP 11 (1999)-512772A disclosed also water-dispersible blocked polyisocyanate compound which is made with use of a specific blocking agent. Because introduction of hydroxyl groups into the blocked polyisocyanate compound is effected by reaction with isocyanate groups, however, the isocyanate group concentration in the resulting blocked polyisocyanate compound is reduced to lower its curability. Furthermore, there is still another problem that the compound's compatibility with the base resin drops to impair finished appearance, because of high polarity of the compound.

Water-based one package coat containing blocked polyisocyanate compound as crosslinking agent initiates the curing reaction after detachment of the blocking agent. Where the detachment is incomplete, there rises another problem that sufficient curability cannot be obtained, which leads to unsatisfactory performance of the coating film. Furthermore, at the coating film surface layer where detachment and volatilization of the blocking agent are apt to take place, the reaction progresses more rapidly than at the inside of the layer, which lowers the adhesion-participating functional group concentration at the coating film surface, and when another paint is applied onto the cured coating film surface, adherability of the surface to the upper layer coating film may become insufficient.

### DISCLOSURE OF THE INVENTION

An object of the present invention is to provide water-based one package coat excelling in curability, coating film performance such as hardness, acid resistance and scratch resistance, coated surface smoothness and aqueous dispersion stability; and a method for forming multilayer coating film using the water-based one package coat.

We have made concentrative studies on relevancy of the base resin and hydrophobic blocked polyisocyanate compound as the crosslinking agent in water-based one package coat to its performance such as curability, adherability, coated surface smoothness and aqueous dispersion stability, to now discover that the above object could be accomplished by a water-based one package coat which comprises, as the base resin, an acrylic resin having long chain hydroxyl-containing side chains such as at least C₄ primary hydroxyalkyl, at least C₄ primary hydroxypolyoxyalkylene or the like as the crosslinking functional group and having a solubility parameter falling within a specific range; and as the crosslinking agent, a blocked polyisocyanate compound having a solubility parameter falling within a specific range; and in which the difference between the solubility parameter of the acrylic resin and that of the blocked polyisocyanate compound falls within a specific range. The present invention is whereupon completed.

Thus, the present invention provides a water-based one package coat characterized in that it is a paint composition comprising

(1) an acrylic resin (A) obtained through copolymerization of

(a) 20-60 mass % of at least one hydroxyl-containing (meth)acrylic acid ester represented by the following formula (I):

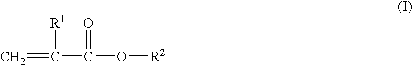

in which

R¹ stands for hydrogen or methyl, and

R² stands for at least C₄ primary hydroxyalkyl, at least C₄ primary hydroxypolyoxyalkylene or an organic substituent of the following formula (II):

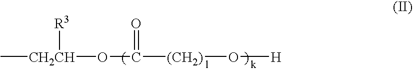

in which R³ stands for hydrogen or methyl, l is an integer of 2-5, and k is an integer of 1-7;

(b) 0.7-15 mass % of at least one vinyl monomer containing carboxyl group, sulfonic acid group or phosphoric acid group; and

(c) 25-79.3 mass % of at least one other copolymerizable vinyl monomer;

said resin (A) having a hydroxyl value of 110-200 mgKOH/g and an acid value of 5-50 mgKOH/g:
and

(2) at least one blocked polyisocyanate compound (B),

and in that the solubility parameter (SP1) of the acrylic resin (A) is 9.30-11.20, that (SP2) of the blocked polyisocyanate compound (B) is 9.00-11.50, and the difference ΔSP between the solubility parameter (SP1) of the acrylic resin (A) and the solubility parameter (SP2) of the blocked polyisocyanate compound (B) (ΔSP=(SP1)−(SP2)) is within a range of from −0.80 to 1.50,

the blocked polyisocyanate compound (B) comprises an azole compound-blocked polyisocyanate compound, and

the paint composition further contains organotin compound and/or bismuth compound as the catalyst.

The invention also provides a multilayer coating film-forming method comprising successively applying onto a coating object at least one layer of base coat paint and at least one layer of clear coat paint, characterized by applying as the top clear coat paint the above water-based one package coat.

The invention furthermore provides a multilayer coating film-forming method comprising applying onto a coating object a thermosetting water-based paint composition as the base coat paint, applying onto the uncured coated surface the above water-based one package coat as the clear coat paint, and curing the base coat and clear coat simultaneously.

According to the present invention, the solubility parameter (SP1) of the acrylic resin serving as the base resin in the water-based one package coat and that (SP2) of the blocked polyisocyanate compound as the crosslinking agent are within the specified ranges, and the difference (ΔSP=(SP1)−(SP2)) between these solubility parameters is as small as within the range of from −0.80 to 1.50 and hence the base resin and the crosslinking agent are highly compatible. Compared to water-based one package coat containing conventional blocked polyisocyanate compound as crosslinking agent, in the product of the invention the blocked polyisocyanate compound can be stably dispersed in the water-based paint, and hence the product excels in aqueous dispersion stability and also in smoothness of the coating film surface.

Still in addition, because the water-based one package coat of the invention exhibits sufficient curability because the acrylic resin serving as its base resin contains as crosslinking functional groups the specified amount of long chain hydroxyl-containing side chains such as at least C₄ primary hydroxyalkyl, at least C₄ primary hydroxypolyoxyalkylene or the like. Also because the solubility parameter of the blocked polyisocyanate compound which is used as the crosslinking agent is within the specified range, coating film of excellent performance, e.g., hardness and acid resistance, can be obtained. Moreover, reactivity of residual hydroxyl groups which participate in adherability on the coated film surface increases, which leads to an effect, when another paint is applied on the top of the cured coating film, that its adherability (recoat adherability) to the upper coating film is improved.

### DETAILED DESCRIPTION OF THE INVENTION

Hereinafter the water-based one package coat (hereafter may be referred to as “the present paint composition”) and the multilayer film-forming method of the present invention are explained in further details.

### Water-Based One Package Coat

The water-based one package coat of the invention is characterized by comprising as the base resin an acrylic resin (A) having, as crosslinking functional group, long chain hydroxyl-containing side chains such as at least C₄ primary hydroxyalkyl, at least C₄ primary hydroxypolyoxyalkylene or the like, and having a solubility parameter within the specified range; and as the crosslinking agent blocked polyisocyanate compound (B) having a solubility parameter within the specified range; the difference between the solubility parameter (SP1) of the acrylic resin (A) and that (SP2) of the blocked polyisocyanate compound (B) being within the specified range.

### Acrylic Resin (A)

The acrylic resin (A) used in the present paint composition is an acrylic resin having specific primary hydroxyl groups as the crosslinking functional group, which can be obtained through copolymerization of the following monomers (a), (b) and (c):

(a) at least one hydroxyl-containing (meth)acrylic acid ester represented by the following formula (I):

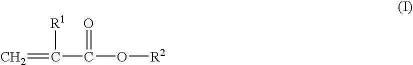

in which

R¹ stands for hydrogen or methyl, and

R² stands for at least C₄ primary hydroxyalkyl, at least C₄ primary hydroxypolyoxyalkylene or an organic substituent of the following formula (II):

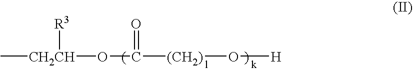

in which R³ stands for hydrogen or methyl, l is an integer of 2-5, in particular, an integer of 3-5, and k is an integer of 1-7, in particular, an integer of 2-6;

(b) at least one vinyl monomer containing carboxyl group, sulfonic acid group or phosphoric acid group; and

(c) at least one other copolymerizable vinyl monomer.

(a) Hydroxyl-Containing (Meth)Acrylic Acid Ester:

Examples of the hydroxyl-containing (meth)acrylic acid ester (a) of the formula (I) in which R² stands for primary hydroxyalkyl group containing at least 4, preferably 4-12, inter alia, 4-10, carbon atoms include 4-hydroxybutyl(meth)acrylate, 5-hydroxypentyl (meth)acrylate, 1-methyl-4-hydroxybutyl (meth)acrylate, 6-hydroxyhexyl(meth)acrylate, 1-methyl-5-hydroxypentyl (meth)acrylate, 7-hydroxyheptyl(meth)acrylate, 8-hydroxyoctyl (meth)acrylate, 9-hydroxynonyl(meth)acrylate and 10-hydroxydecyl (meth)acrylate. Of these, 4-hydroxybutyl (meth)acrylate is preferred from the viewpoints of curability and glass transition temperature of the acrylic resin.

Examples of the hydroxyl-containing (meth)acrylic acid ester (a) of the formula (I) in which R² stands for primary hydroxypolyoxyalkylene group containing at least 4, preferably 4-14, inter alia, 4-10, carbon atoms include polyalkylene oxide adducts of hydroxyalkyl(meth)acrylate. Here the hydroxyalkyl(meth)acrylate can be, for example, 2-hydroxyethyl(meth)acrylate, 2-hydroxypropyl (meth)acrylate and the like. Also as the polyalkylene oxide, for example, polyethylene oxide, polypropylene oxide, polybutylene oxide, copolymers of polyethylene oxide with polybutylene oxide, and copolymers of polypropylene oxide with polyethylene oxide can be named. Specific examples include BLENMER PE-90, PE-200 and 55 PET-400 (tradenames) of NOF Corporation.

The term “(meth)acrylate” as used in this specification means acrylate or methacrylate, “(meth)acrylic acid” means acrylic acid or methacrylic acid, and “(meth)acryloyl” means acryloyl or methacryloyl.

Examples of the hydroxyl-containing (meth)acrylic acid ester (a) of the general formula (I) in which R² is an organic substituent represented by the general formula (II) include ε-caprolactone- or γ-butyrolactone adducts of 2-hydroxypropyl(meth)acrylate or 2-hydroxyethyl (meth)acrylate. More specifically, PLACCEL™ series monomers by Daicel Chemical Industries, Ltd., such as PLACCEL FM1, PLACCEL FM2, PLACCEL FA2 and PLACCEL FM6 can be used.

Above hydroxyl-containing (meth)acrylic acid esters (a) can be used either alone or in combination of two or more.

The use rate of the hydroxyl-containing (meth)acrylic acid (a) can be 20-60 mass %, preferably 25-55 mass %, inter alia, 25-45 mass %, based on the total mass of the monomers (a), (b) and (c). When the use rate of the hydroxyl-containing (meth)acrylic acid ester (a) is less than 20 mass %, curability of the coating film becomes insufficient, which occasionally leads to insufficient coating film performance such as film hardness or reduction in recoat adherability. Conversely, when it exceeds 60 mass %, the coating film may have inferior water resistance.

The use of 20-60 mass % of the hydroxyl-containing (meth)acrylic acid ester in the acrylic resin (A) approximately corresponds to 80-200 mgKOH/g when converted to the hydroxyl value attributable to the hydroxyl-containing (meth)acrylic acid ester (a). Thus, the acrylic resin (A) can have a hydroxyl value attributable to the hydroxyl-containing (meth)acrylic acid ester (a) generally within a range of 80-200 mgKOH/g, in particular, 90-180 mgKOH/g, inter alia, 110-180 mgKOH/g.

(b) Vinyl Monomer

The vinyl monomer (b) which is the second component used in preparation of acrylic resin (A) is a monomer containing at least 1, preferably 1-12, inter alia, 1-8, carboxyl, sulfonic acid or phosphoric acid groups per molecule.

Examples of carboxyl-containing monomer include (meth)acrylic acid, fumaric acid, crotonic acid, itaconic acid, itaconic acid monomethyl ester, itaconic acid monobutyl ester, maleic acid and maleic anhydride, maleic acid monomethyl ester, maleic acid monobutyl ester and maleic acid monooctyl ester.

Examples of sulfonic acid group-containing monomer include vinylsulfonic acid, vinylbenzenesulfonic acid and sulfoethyl (meth)acrylate.

Examples of phosphoric acid group-containing monomer include 2-(meth)acryloyloxyethyl acid phosphate, 2-(meth)acryloyloxypropyl acid phosphate, 2-(meth)acryloyloxy-3-chloropropyl acid phosphate and 2-methacryloyloxyethylphenyl-phosphoric acid. As those commercially available, KAYAMER PM21 (tradename, Nippon Kayaku Co., Ltd.) and Light Ester PM (tradename, Kyoeisha Chemical Co., Ltd.) can be named.

These vinyl monomers (b) can be used either singly or in combination of two or more.

The use rate of the vinyl monomer (b) can be 0.7-15 mass %, preferably 1-10 mass %, inter alia, 2-6 mass %, based on the combined mass of the monomers (a), (b) and (c). Where the use rate of the vinyl monomer (b) is less than 0.7 mass %, aqueous dispersion stability of the acrylic resin (A) or curability of the paint composition may become insufficient. Conversely, where it exceeds 15 mass %, water resistance of the coating film may decrease.

The use rate ranging 0.7-15 mass % of the vinyl monomer (b) in the acrylic resin (A) corresponds to the acid value of approximately 5-50 mgKOH/g of the acrylic resin (A). Thus, the acrylic resin (A) can have an acid value within a range of generally 5-50 mgKOH/g, in particular, 10-40 mgKOH/g, inter alia, 20-35 mgKOH/g.

In the acrylic resin (A), those carboxyl groups, sulfonic acid groups or phosphoric acid groups which are introduced by the vinyl monomer (b) contribute mainly to impart water dispersibility to the resin, and also act as internal catalyst when the acrylic resin (A) crosslinks with the blocked polyisocyanate compound (B).

(c) Other Vinyl Monomers:

Specific examples of other vinyl monomers (c) copolymerizable with the monomers (a) and (b), which are used in the preparation of the acrylic resin (A) include those named in the following (1)-(9).

(1) Hydroxyl-containing monomers other than the hydroxyl-containing (meth)acrylic acid ester (a): for example, hydroxyalkyl esters of (meth)acrylic acid such as 2-hydroxyethyl(meth)acrylate, 2-hydroxypropyl (meth)acrylate, 3-hydroxypropyl(meth)acrylate, 2-hydroxybutyl (meth)acrylate and 3-hydroxybutyl(meth)acrylate.

Where hydroxyl-containing monomer other than the hydroxyl-containing (meth)acrylic acid ester (a) is used, its use rate can be such an amount, as combined with the hydroxyl-containing (meth)acrylic acid ester (a), that renders the hydroxyl value of the acrylic resin (A) within a range of generally 110-200 mgKOH/g, preferably 120-180 mgKOH/g, inter alia, 130-170 mgKOH/g.

(2) Monoesterified products of (meth)acrylic acid with C₁₋₂₀, in particular, C₁₋₁₂ monohydric alcohol: for example, methyl (meth)acrylate, ethyl(meth)acrylate, propyl(meth)acrylate, n-butyl (meth)acrylate, iso-butyl(meth)acrylate, tert-butyl(meth)acrylate, sec-butyl(meth)acrylate, cyclohexyl(meth)acrylate, benzyl (meth)acrylate, 2-ethylhexyl(meth)acrylate, lauryl(meth)acrylate, isobornyl(meth)acrylate, tridecyl(meth)acrylate, cetyl (meth)acrylate and stearyl(meth)acrylate.

(3) Styrene derivatives: for example, styrene, α-methylstyrene and vinyltoluene.

(4) Epoxy-containing monomers: compounds containing at least one each of glycidyl group and polymerizable unsaturated bond per molecule, specific examples including glycidyl(meth)acrylate, (meth)allylglycidyl ether and metaglycidyl(meth)acrylic acid ester.

(5) Polymerizable unsaturated amides: for example, acrylamide, methacrylamide, dimethylacrylamide, N-methoxymethyl (meth)acrylamide, N,N-dimethylpropyl(meth)acrylamide, N-butoxymethyl (meth)acrylamide, N-methylol (meth)acrylamide and diacetonacrylamide.

(6) Basic monomers: for example, dimethylaminoethyl (meth)acrylic acid.

(7) Other vinyl compounds: for example, vinyl acetate, vinyl propionate, vinyl chloride and versatic acid vinyl ester. Here as the versatic acid vinyl ester, commercially available Veo Va 9 and Veo Va 10 (tradename, Japan Epoxy Resin Co.) and the like can be named.

(8) Polymerizable unsaturated nitrites: for example, acrylonitrile and methacronitrile.

(9) Polyoxyalkylene-containing monomers (excepting those included in hydroxyl-containing (meth)acrylic acid ester (a)): for example, (meth)acrylates having polyoxyethylene group whose molecular side chain terminal is methoxy group. As commercially available examples, BLENMER PME-400, BLENMER PME-4000 (tradenames, NOF Corporation) and the like can be used. Such a monomer containing polyoxyalkylene group whose molecular side chain terminal is methoxy group can be used, for example, when the acrylic resin (A) has a low acid value (i.e., has a low vinyl monomer (b) content), to improve aqueous dispersion stability of the acrylic resin (A).

Those copolymerizable other vinyl monomers (c) can be used either alone or in combination of two or more.

The acrylic resin (A) can have a hydroxyl value within a range of generally 110-200 mgKOH/g, preferably 120-180 mgKOH/g, inter alia, 130-170 mgKOH/g; and an acid value within a range of generally 5-50 mgKOH/g, in particular, 10-40 mgKOH/g, inter alia, 20-35 mgKOH/g, in order to secure satisfactory curability and water resistance and surface smoothness of the coating film.

The acrylic resin (A) can also have a weight-average molecular weight within a range of normally 2,000-30,000, preferably 3,000-17,000, inter alia, 4,000-15,000, to secure satisfactory coating film performance such as acid resistance and coated surface smoothness.

In the present specification, “weight-average molecular weight” is a value calculated from a chromatogram measured with gel permeation chromatograph, based on the molecular weight of standard polystyrene. The measurement of weight-average molecular weight in the later appearing Production Examples was carried out using as the gel permeation chromatograph HLC8120GPC (tradename, Tosoh Corporation) and four columns of TSKgel G-4000HXL, TSKgel G-3000HXL, TSKgel G-2500-HXL and TSKgel G-2000HXL (tradenames, Tosoh Corporation), under the conditions of mobile phase; tetrahydrofuran, measuring temperature; 40° C., flow rate; 1 cc/min. and detector; RI.

The acrylic resin (A) preferably has a glass transition temperature normally within a range of −30° C.-40° C., in particular, −20° C.-30° C., in respect of hardness of the coating film and coated surface smoothness.

In the present specification, “glass transition temperature” is a value measured with DSC (differential scanning calorimeter) at a temperature rise rate of 10° C./min. following JIS K7121 (transition temperature measuring method for plastics). The measurement of glass transition temperature in the later appearing Production Examples was carried out using SSC 5200 (tradename, Seiko Instruments & Electronics Ltd.) as DSC, after drying each specified amount of measured out test specimen on a sample dish at 130° C. for 3 hours.

For preparing the acrylic resin (A), the hydroxyl-containing (meth)acrylic acid ester (a), vinyl monomer (b) and other vinyl monomer (c) copolymerizable therewith, can be copolymerized in the respective amounts within the following ranges, based on the total amount of the monomers (a), (b) and (c):
hydroxyl-containing (meth)acrylic acid ester (a): 20-60 mass %, preferably 25-55 mass %, inter alia, 25-45 mass %
vinyl monomer (b): 0.7-15 mass %, preferably 1-10 mass %, inter alia, 2-6 mass %
copolymerizable other vinyl monomer (c): 25-79.3 mass %, preferably 35-75 mass %, inter alia, 49-73 mass %.

As polymerization method of the monomers (a), (b) and (c), those known per se, such as solution polymerization method, bulk polymerization method, emulsion polymerization method and the like can be used, solution polymerization being particularly convenient. The solution polymerization can normally be carried out in the presence of organic solvent and polymerization initiator, by copolymerizing a mixture of the monomers (a), (b) and (c). As useful organic solvent, for example, hydrophilic organic solvent such as an alcohol type like isopropyl alcohol, ester type like butyl acetate, ethylene glycol ether type or diethylene glycol ether type are preferred in respect of water dispersibility. As the polymerization initiator, those customarily used, e.g., azobisisobutyronitrile, benzoyl peroxide, di-tert-amyl peroxide, di-tert-butyl peroxide, tert-butyl-peroxy-2-ethyl hexanoate, tert-amyl-peroxy-2-ethyl hexanoate, cumene hydroperoxide and the like, can be used, and where necessary, a chain transfer agent such as 2-mercaptoethanol, n-octylmercaptane and the like may be concurrently used.

The copolymerization of the acrylic resin (A) can be effected either by single-stage polymerization process or multistage polymerization process comprising at least two stages. In the solution polymerization method, single-stage polymerization comprises dropping all of the monomeric components and the polymerization initiator into a reaction vessel in the presence of a solvent, over a prescribed period. Whereas, multistage polymerization does not drop all the monomeric components concurrently, but divides the monomeric components into at least two parts and successively drops them into the reaction vessel.

From the viewpoint of improving water dispersibility of the acrylic resin (A) and aqueous dispersion stability of the paint composition prepared therefrom, the acrylic resin (A) synthesized by multistage polymerization comprising at least two stages is preferred.

More specifically, acrylic resins of good aqueous dispersion stability which are obtained by two-stage polymerization process comprising, for example, first polymerizing the monomeric component containing no or little hydrophilic group-containing monomer(s), and thereafter adding (dropping) the monomeric component containing hydrophilic group-containing monomer(s) for further polymerization are preferred.

Acrylic resins (A) can be used either singly or in combination of two or more.

### Blocked Polyisocyanate Compound (B)

Blocked polyisocyanate compound (B) which is used as crosslinking agent in the present paint composition is obtained by blocking isocyanate groups of a compound having at least two free isocyanate groups per molecule, with a blocking agent.

As the polyisocyanate compound, those customarily used in the occasion of polyurethane preparation, for example, aliphatic polyisocyanate, alicyclic polyisocyanate, aromatic-aliphatic polyisocyanate, aromatic polyisocyanate and derivatives of these polyisocyanates (e.g., urethane group-, carbodiimido group-, allophanate group-, urea group-, biuret group-, urethodione group-, urethoimine group-, isocyanurate group- or oxazolidone group-containing modification products) can be named.

Examples of the aliphatic polyisocyanate include aliphatic diisocyanates such as ethylene diisocyanate, trimethylene diisocyanate, tetramethylene diisocyanate, hexamethylene diisocyanate, pentamethylene diisocyanate, dodecamethylene diisocyanate, lysine diisocyanate, 1,2-prophylene diisocyanate, 1,2-butylene diisocyanate, 2,3-butylene diisocyanate, 1,3-butylene diisocyanate, 2,4,4- or 2,2,4-trimethylhexamethylene diisocyanate, bis(2-isocyanatoethyl)fumarate, bis(2-isocyanateoethyl)carbonate, 2,6-diisocyanatomethyl caproate, 2-isocyanatoethyl-2,6-diisocyanatohexanoate and the like; and aliphatic triisocyanates such as lysine ester triisocyanate, 1,4,8-triisocyanatooctane, 1,6,11-triisocyanatoundecane, 1,8-diisocyanato-4-isocyanatomethyloctane, 1,3,6-triisocyanatohexane, 2,5,7-trimethyl-1,8-diisocyanato-5-isocyanatomethyloctane and the like.

Examples of the alicyclic polyisocyanate include alicyclic diisocyanates such as 1,3-cyclopentene diisocyanate, 1,4-cyclohexane diisocyanate, 1,3-cyclohexane diisocyanate, 3-isocyanatomethyl-3,5,5-trimethylcyclohexyl isocyanate (common name: isophorone diisocyanate), 4,4′-methylenebis(cyclohexylisocyanate), methyl-2,4-cyclohexane diisocyanate, methyl-2,6-cyclohexane diisocyanate, 1,3-bis(isocyanatomethyl)cyclohexane, 1,4-bis(isocyanatomethyl)-cyclohexane, norbornane diisocyanate, dicyclohexylmethane-4,4′-diisocyanate (hydrogenated MDI), cyclohexylene diisocyanate, methyl cyclohexylene diisocyanate (hydrogenated TDI), bis(2-isocyanatoethyl)-4-cyclohexene-1,2-dicarboxylate and the like; and alicyclic triisocyanates such as 1,3,5-triisocyanatocyclohexane, 1,3,5-trimethylisocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo(2.2.1)heptane, 5-(2-isocyanatoethyl)-2-isocyanatomethyl-3-(3-isocyanatopropyl)-bicyclo(2.2.1)heptane, 6-(2-isocyanatoethyl)-2-isocyanatomethyl-3-(3-isocyanatopropyl)-bicyclo(2.2.1) heptane, 5-(2-isocyanatoethyl)-2-isocyanatomethyl-2-(3-isocyanatopropyl)-bicyclo(2.2.1)heptane, 6-(2-isocyanatoethyl)-2-isocyanatomethyl-2-(3-isocyanatopropyl)-bicyclo(2.2.1)heptane and the like.

Examples of the aromatic-aliphatic polyisocyanate include aromatic-aliphatic diisocyanates such as 1,3- or 1,4-xylylene diisocyanate or mixtures thereof, ω,ω′-diisocyanato-1,4-diethylbenzene, 1,3- or 1,4-bis(1-isocyanato-1-methylethyl)benzene (common name: tetramethylxylylene diisocyanate) or mixtures thereof, and aromatic-aliphatic triisocyanates such as 1,3,5-triisocyanatomethylbenzene and the like.

Examples of the aromatic polyisocyanate include aromatic diisocyanates such as m-phenylene diisocyanate, p-phenylene diisocyanate, 4,4′-diphenyl diisocyanate, 3,3′-dimethyl-4,4′-diisocyanatobiphenyl, 3,3′-dimethyl-4,4′-diisocyanatodiphenylmethane, 1,5-naphthalene diisocyanate, 2,4′- or 4,4′-diphenylmethane diisocyanate (MDI) or mixtures thereof, 2,4- or 2,6-tolylene diisocyanate or mixtures thereof, 4,4′-toluidine diisocyanate, 4,4′-diphenylether diisocyanate, m- and p-isocyanatophenysulfonyl isocyanate and the like; aromatic triisocyanates such as triphenylmethane-4,4′,4″-triisocyanate, 1,3,5-triisocyanatobenzene and 2,4,6-triisocyanatotoluene; and aromatic tetraisocyanates such as 4′,4′-diphenylmethane-2,2′,5,5′-tetraisocyanate and the like.

Also as examples of the polyisocyanate derivatives, various derivatives of above polyisocyanate compounds such as their dimers, trimers, biurets, allophanates, carbodiimides, urethodiones, urethoimines, isocyanurates, iminoxadiazinediones and the like can be named.

These polyisocyanate compounds can be used either alone or in combination of two or more. Of these polyisocyanate compounds, aliphatic polyisocyanate, alicyclic polyisocyanate and derivatives thereof are preferred for excellent weatherability of resulting cured coating film, among which hexamethylene diisocyanate (HDI), derivatives thereof, isophorone diisocyanate (IPDI) and derivatives thereof are particularly preferred.

The blocked polyisocyanate compound preferably has a number-average molecular weight generally no more than 3,000, in particular, within a range of 300-2,000, inter alia, 500-1,500, in respect of the finished quality and water dispersibility.

In the present specification, number-average molecular weight of the blocked polyisocyanate compound is a value calculated from a chromatogram measured with gel permeation chromatograph, based on the molecular weight of standard polystyrene. The measurement of number-average molecular weight in the later-appearing Production Examples was carried out using as the gel permeation chromatograph HLC8120GPC (tradename, Tosoh Corporation) and four columns of TSKgel G-400HXL, TSKgel G-300HXL, TSKgel G-2500-HXL and TSKgel G-200HXL (tradenames, Tosoh Corporation), under the conditions of mobile phase; tetrahydrofuran, measuring temperature; 40° C., flow rate; 1 cc/min. and detector; RI.

Blocking agent is a compound for temporarily blocking free isocyanate group, and when the isocyanate group blocked with the blocking agent is heated to the baking temperature of the coating film, e.g., to no lower than 100° C., preferably no lower than 130° C., the blocking agent dissociates to regenerate the free isocyanate group which easily reacts with hydroxyl group or the like in the base resin.

Examples of the blocking agent include phenols such as phenol, cresol, xylenol, nitrophenol, ethylphenol, hydroxydiphenyl, butylphenol, isopropylphenol, nonylphenol, octylphenol, methyl hydroxybenzoate and the like; lactams such as ε-caprolactam, δ-valerolactam, γ-butyrolactam, β-propiolactam and the like; aliphatic alcohols such as methanol, ethanol, propyl alcohol, butyl alcohol, amyl alcohol, lauryl alcohol and the like; ethers such as ethylene glycol monomethyl ether, ethylene glycol monoethyl ether, ethylene glycol monobutyl ether, diethylene glycol monomethyl ether, diethylene glycol monoethyl ether, propylene glycol monomethyl ether, methoxymethanol and the like; benzyl alcohol; glycolic acid; glycolic acid esters such as methyl glycolate, ethyl glycolate, butyl glycolate and the like; lactic acid; lactic acid esters such as methyl lactate, ethyl lactate, butyl lactate and the like; alcohols such as methylolurea, methylolmelamine, diacetone alcohol, 2-hydroxyethyl acrylate, 2-hydroxyethyl methacrylate and the like; oximes such as formamidoxime, acetamidoxime, acetoxime, methyl ethyl ketoxime, diacetylmonooxime, benzophenone-oxime, cyclohexane-oxime and the like; active methylenes such as dimethyl malonate, diethyl malonate, ethyl acetoacetate, methyl acetoacetate, acetylacetone and the like; mercaptans such as butyl mercaptan, t-butyl mercaptan, hexyl mercaptan, t-dodecyl mercaptan, 2-mercaptobenzothiazole, thiophenol, methylthiophenol, ethylthiophenol and the like; acid amides such as acetanilide, acetanisidide, acetotoluide, acrylamide, methacrylamide, acetic acid amide, stearic acid amide, benzamide and the like; imides such as succinimide, phathalimide, maleimide and the like; amines such as diphenylamine, phenylnaphthylamine, xylidine, N-phenylxylidine, carbazole, aniline, naphthylamine, butylamine, dibutylamine, butylphenylamine and the like; imidazoles such as imidazole, 2-ethyl-imidazole and the like; ureas such as urea, thiourea, ethyleneurea, ethylenethiourea, diphenylurea and the like; carbamic acid esters such as phenyl N-phenylcarbamate; imines such as ethyleneimine, propyleneimine and the like; sulfites such as sodium disulfite, potassium disulfite and the like; and azole compounds. As examples of the azole compound, pyrazoles or derivatives thereof such as pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, 3-methyl-5-phenylpyrazole and the like; imidazoles or derivatives thereof such as imidazole, benzimidazole, 2-methylimidazole, 2-ethylimidazole, 2-phenylimidazole and the like; and imidazoline derivatives such as 2-methylimidazoline, 2-phenylimidazoline and the like can be named.

Of those blocking agents, azole compounds such as pyrazole or pyrazole derivatives are preferred because of favorable low temperature curability and yellowing resistance, 3,5-dimethylpyrazole being particularly preferred.

### Solubility Parameter

The water-based one package coat of the present invention comprises, as aforesaid, acrylic resin (A) and at least one blocked polyisocyanate compound (B), the solubility parameter (SP1) of the acrylic resin (A) ranging 9.30-11.20, that (SP2) of the blocked polyisocyanate compound (B) ranging 9.00-11.50, and the difference ΔSP between the solubility parameter (SP1) and the solubility parameter (SP2)(ΔSP=(SP1)−(SP2)) ranging from −0.80 to 1.50.

Where the solubility parameter (SP1) of the acrylic resin (A) exceeds 11.20, the high polarity may cause decrease in water dispersibility of the blocked polyisocyanate compound (B) or reduction in acid resistance of formed coating film. Conversely, where it is less than 9.30, the low polarity may invite reduction in water dispersibility of the blocked polyisocyanate compound.

Where the solubility parameter (SP2) of the blocked polyisocyanate compound (B) exceeds 11.50, furthermore, due to the high polarity water resistance or acid resistance of the formed coating film or the water dispersibility attributable to the acrylic resin (A) may drop. Conversely, where it is less than 9.00, the low polarity may decrease the water dispersibility attributable to the acrylic resin (A).

Moreover, when the difference ΔSP between the solubility parameter (SP1) of the acrylic resin (A) and that (SP2) of the blocked polyisocyanate compound (ΔSP=(SP1)−(SP2)) is less than −0.80, due to the low polarity of the acrylic resin (A), water dispersibility of the blocked polyisocyanate compound (B) may decrease, and compatibility of the component (A) and component (B) may also decrease to impair smoothness of the coating film. Conversely, when ΔSP value exceeds 1.50, compatibility of the component (A) and component (B) decreases, which may result in less surface smoothness of the formed coating film or decrease in the blocked polyisocyanate compound-dispersing ability in water of the acrylic resin (A).

Thus, the solubility parameter (SP1) of the acrylic resin (A) used in the water-based one package coat of the present invention preferably lies within a range of 9.30-11.20, in particular, 9.50-11.00, inter alia, 9.70-10.60. Also the solubility parameter (SP2) of the blocked polyisocyanate compound (B) preferably lies within a range of 9.00-11.50, in particular, 9.20-10.50, inter alia, 9.20-10.00.

The difference ΔSP between the solubility parameter (SP1) of the acrylic resin (A) and that (SP2) of the blocked polyisocyanate compound (B) preferably lies within a range of from −0.80 to 1.50, in particular, from −0.20 to 1.30, inter alia, 0.50-1.20, in respect of water dispersibility and smoothness of the coating film.

Those solubility parameter values (SP values) of the acrylic resin (A) and blocked polyisocyanate compound (B) as referred to herein are measured by turbidimetric titraction which is a convenient actual measuring method, and are calculated by the following K. W. Suh, J. M. Corbett's equation (Journal of Applied Polymer Science, 12, 2359, 1968):

$$S P = \frac{\sqrt{{V}^{H}} \cdot {δ}^{H} + \sqrt{{V}^{D}} \cdot {δ}^{D}}{\sqrt{{V}_{H}} + \sqrt{{V}_{D}}}$$

The solubility parameter (SP) is a value determined as follows: 0.5 g (solid content) of dried acrylic resin or blocked polyisocyanate compound is placed in a tall beaker of 50 mm in inner diameter (capacity=100 ml) and dissolved in 10 ml of acetone. Into the solution n-hexane is added dropwise at 25° C. under stirring, until No. 4 type letters of a sheet of news paper spread under the bottom of the beaker become illegible from the top of the beaker, and the legible limit is marked as the cloud point. The titrated amount H (ml) at the cloud point is read. Similarly, deionized water instead of n-hexane was titrated into the acetone solution, and its titrated amount D (ml) at the cloud point is read. The values V_{H}, V_{D}, δ_{H} and δ_{D} as calculated from these titrated amounts according to the following equations are applied to aforesaid K. W. Suh, J. M. Corbett's equation. The SP values of the solvents are as follows: n-hexane, 7.24; deionized water, 23.43; and acetone, 9.75.

V_{H}=H/(10+H)

V_{D}D/(10+D)

δ_{H}=9.75×10/(10+H)+7.24×H/(10+H)

δ_{D}=9.75×10/(10+D)+23.43×D/(10+D)

In the water-based one package coat of the present invention, preferred blend ratio of the acrylic resin (A) and the blocked polyisocyanate compound (B) is such that the equivalent ratio of the isocyanate groups in the blocked polyisocyanate compound (B) to the hydroxyl groups in the acrylic resin (A), (NCO/OH), would fall within a range of generally 0.5-1.0, in particular, 0.6-0.9, inter alia, 0.7-0.9. Where the equivalent ratio is less than 0.5, the subject coat may have reduced curability, and where it exceeds 1.0, the amount of the hydroxyl group remaining on the coating film surface is reduced, and the film's adherability to non-sand recoat may decrease.

According to preferred blend ratio between the acrylic resin (A) and the blocked polyisocyanate compound (B), acrylic resin (A) can be within a range of generally 50-75 mass %, in particular, 55-70 mass %, inter alia, 60-70 mass %; and blocked polyisocyanate compound (B), within a range of generally 25-50 mass %, in particular, 30-45 mass %, inter alia, 30-40 mass %, based on 100 mass % of the combined solid content of the two components.

The paint composition of the invention may further contain melamine resin as additional crosslinking agent. Examples of the melamine resin include methylolmelamines such as dimethylolmelamine, trimethylolmelamine, tetramethylolmelamine, pentamethylolmelamine and hexamethylolmelamine; alkyletherified or condensation products of these methylolmelamines; and condensation products of alkyletherified methylolmelamines. Alkyletherification of methylolmelamines can be carried out by a method known per se, using monohydric alcohol such as methyl alcohol, ethyl alcohol, propyl alcohol, isopropyl alcohol, butyl alcohol, isobutyl alcohol, ethylhexyl alcohol and the like.

As the melamine resin, those on the market can also be used. As such, for example, CYMEL 303, CYMEL 323, CYMEL 325, CYMEL 327, CYMEL 350, CYMEL 370, CYMEL 380, CYMEL 385, CYMEL 212, CYMEL 251, CYMEL 254, and MYCOAT 776 by Cytec Industries; REGIMIN 735, REGIMIN 740, REGIMIN 741, REGIMIN 745, REGIMIN 746 and REGIMIN 747 by Monsanto Chemical Co.; SUMIMAL M55, SUMIMAL M30W and SUMIMAL M50W by Sumitomo Chemicals; U-VAN20SB, U-VAN20SE-60, U-VAN28-60 by Mitsui Chemicals; and the like (all by tradenames) can be named.

When melamine resin is used, its blend ratio preferably is no more than 15 mass parts, in particular, 0-10 mass parts, per 100 mass parts of combined solid content of the acrylic resin (A) and blocked polyisocyanate compound (B).

In the paint composition of the invention, organotin compound and/or bismuth compound is used as the curing catalyst. Examples of the organotin compound include aliphatic or aromatic carboxylates of dialkyltin such as dibutyltin dilaurate, dioctyltin dilaurate, dibutyltin diacetate, dibutyltin phthalate, dioctyltin dibenzoate and dibutyltin dibenzoate; aliphatic or aromatic carboxylates of monoalkyltin such as monobutyltin trioctylate; and distannoxanes such as tetra-n-butyl-1,3-diacetoxy-distannoxane.

Examples of the bismuth compound include inorganic bismuth compounds such as bismuth oxide, bismuth hydroxide, basic bismuth carbonate, bismuth nitrate and bismuth silicate.

Also as the bismuth compound, organic acid-derived bismuth compounds obtained through reaction of organic acid such as acetic acid, octylic acid, glyolic acid, glyceric acid, lactic acid, dimethylolpropionic acid, dimethylolbutyric acid, dimethylolvaleric acid, tartaric acid, malic acid, hydroxymalonic acid, dihydroxysuccinic acid, trihydroxysuccinic acid, methylmalonic acid, benzoic acid, citric acid and the like, with above-named inorganic bismuth compound can also be used. Of those organic acid-derived bismuth compounds, bismuth trioctylate which is obtained by reacting bismuth hydroxide with octylic acid is particularly preferred.

The preferred content of the organotin compound and/or bismuth compound used as the catalyst in the present paint composition is within a range of normally 0.01-10 mass parts, preferably 0.05-8 mass parts, inter alia, 0.05-1 mass part, per 100 mass parts of the combined solid content of the acrylic resin (A) and blocked polyisocyanate compound (B).

The present paint composition can further contain UV absorber, where necessary. Examples of the UV absorber include triazine compounds and benzotriazole compounds, triazine compounds being particularly preferred for increasing thermal yellowing resistance.

As the triazine compounds, for example, 2-(4,6-diphenyl-1,3,5-triazin-2-yl)-5-[(hexyl)oxy]-phenol (e.g., TINUVIN 1577FF, tradename, Ciba Specialty Chemicals Inc.), mixtures of 2-[4-[6-(2-hydroxy-3-dodecyloxypropyl)oxy]-2-hydroxyphenyl]-4,6-bis(2,4-dimethylphenyl)-1,3,5-triazine with 2-[4-[6(2-hydroxy-3-dodecyloxypropyl)oxy]-2-hydroxyphenyl]-4,6-bis(2,4-dimethylphenyl)-1,3,5-triazine (e.g., TINUVIN 400, tradename, Ciba Specialty Chemicals Inc.), 2,4-bis(2,4-dimethylphenyl)-6-(2-hydroxy-4-iso-octyloxyphenyl)-s-triazine (e.g., TINUVIN 411L, tradename, Ciba Specialty Chemicals Inc.), 2,4-bis(2,4-dimethylphenyl)-6-(2-hydroxy-4-octyloxyphenyl)-1,3,5-triazine (e.g., CYAGARD UV1164L, tradename, Mitsui Cytec K.K.) and the like can be named.

Examples of the benzotriazole compound include 2-(2′-hydroxy-5′-methylphenyl)benzotriazole, 2-[2′-hydroxy-3′,5′-di-(1,1-dimethylbenzyl)phenyl]-2H-benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-amylphenyl)benzotriazole, 2-(2′-hydroxy-3′,5′-di-tert-butylphenyl)-5-chlorobenzotriazole, 2-(2′-hydroxy-3′,5′-di-isoamylphenyl)-benzotriazole, 2-(2′-hydroxy-5′-tert-butylphenyl)benzotriazole and the like.

These UV absorbers can be used either alone or in combination of two or more.

The UV absorber can be contained within a range of generally 0.1-10 mass parts, preferably 0.5-5 mass parts, inter alia, 0.8-3 mass parts, per 100 mass parts of the combined solid content of the acrylic resin (A) and blocked polyisocyanate compound (B).

Where necessary, the paint composition of the invention can further be blended with light stabilizer such as hindered amine-derived light stabilizers, specific examples of which include bis-(2,2′,6,6′-tetramethyl-4-piperidinyl)sebacate, 4-benzoyloxy-2,2′,6,6′-tetramethylpiperidine and the like. Those light stabilizers can be used either alone or in combination of two or more.

Where such light stabilizer is used, its use rate can be within a range of generally 0.1-10 mass parts, preferably 0.5-5 mass parts, inter alia, 0.8-3 mass parts, per 100 mass parts of combined solid content of the acrylic resin (A) and blocked polyisocyanate compound (B).

### Other Components

The water-based one package coat of the present invention can further contain, as necessity arises, resin component such as polyester resin, polyurethane resin and the like; additives such as rheology controlling agent, surface-regulating agent, defoamer, antioxidant and the like; and pigments such as coloring pigment, metallic pigment, iridescent pigment, extender and the like. When the paint composition of the invention is used as clear paint, above-named additives and pigments can be used within a limit not substantially impairing transparency of the coating film.

### Formulation and Application of the Present Paint Composition

The water-based one package coat of the invention can be prepared by adding to the acrylic resin (A) and blocked polyisocyanate compound (B), optional components used where necessary, such as catalyst, UV absorber, light stabilizer and the like, and mixing them with an aqueous medium, e.g., water, to uniformly disperse them in the medium. The mixing and dispersing are preferably carried out by neutralizing the acrylic resin (A) with a neutralizing agent, for improving its water dispersibility. Also in the occasion of this mixing and dispersing, emulsifier may be used concurrently, where necessary, for improving the dispersibility.

Examples of useful neutralizer include hydroxides of alkali metals or alkaline earth metals, such as sodium hydroxide, potassium hydroxide, lithium hydroxide, calcium hydroxide and barium hydroxide; ammonia; primary monoamine compounds such as ethylamine, propylamine, butylamine, cyclohexylamine, monoethanolamine, isopropanolamine, neopentanolamine, 2-aminopropanol, 3-aminopropanol and 2-amino-2-methylpropanol; secondary monoamine compounds such as diethylamine, dibutylamine, diethanolamine, dipropylamine, diisopropanolamine, N-methylethanolamine, N-ethylethanolamine and N-methylisopropanolamine; tertiary monoamine compounds such as triethylamine, tributylamine, dimethylethanolamine, diethylethanolamine, methyldiethanolamine, dimethylaminoethanol and triethanolamine; polyamine compounds such as ethylenediamine, diethylenetriamine, hydroxyethylaminoethylamine, ethylaminoethylamine and methylaminopropylamine; and pyridine, morpholine and the like. Of these, use of primary monoamine compound, secondary monoamine compound, tertiary monoamine compound and polyamine compound is preferred.

Use rate of the neutralizer is not particularly limited, but can be suitably selected as necessity arises. Whereas, with the view to improve dispersion stability, it is preferably used within a range of normally 0.6-1.2 equivalents, in particular, 0.7-1.1 equivalents, per the total amount of acid groups in the acrylic resin (A).

In formulating the present paint composition, the acrylic resin (A) and blocked polyisocyanate compound (B) are normally mixed and dispersed in the form of solutions in organic solvent, and preferably the organic solvent is removed from the paint composition of the invention by such means as reduced pressure distillation as much as possible, for cutting down its VOC content. For suppressing bubbling during the de-organic solvent step by reduced pressure distillation or the like, defoamer may be suitably added.

The water-based one package coat of the invention preferably has a VOC content normally ranging 0-300 g/l, in particular, 0-250 g/l, inter alia, 0-150 g/l. In the present specification, “VOC” means the volatile organic compound classified by World Health Organization (WHO) under “highly voltaic organic compounds” and “volatile organic compounds”.

In the so obtained water-based one package coat of the present invention, the dispersed particles present preferably have an average particle size within a range of generally 100-150 nm, in particular, 100-400 nm, inter alia, 100-300 nm. In the present paint composition, normally the blocked polyisocyanate compound (B) and hydrophobic optional component used where necessary are dispersed in the water as dispersed particles, the acrylic resin (A) serving as the dispersing medium. Where the average particle size of the dispersed particles exceeds 500 nm, storage stability of the present paint composition decreases to tend to degrade smoothness of the coating film, and hence such large average particle size is undesirable. Whereas, when it is less than 100 nm, the paint composition has increased viscosity and the solid concentration of the paint tends to decrease, which also is undesirable.

In this specification, the average particle size of dispersed particles present in the water-based one package coat is the value measured with a submicron particle size distribution measuring device at 20° C., after dispersing the test specimen paint composition in deionized water. As such submicron particle size measuring device, those available in the market, for example, COULTER N4 Model (tradename, Beckman Coulter, Inc.) can be used.

In the occasion of application, the water-based one package coat of the present invention is usually preferably adjusted of its viscosity, where necessary, by dilution with deionized water, to generally 15-60 seconds, in particular, 20-50 seconds, as measured with Ford cup viscosimeter No. 4 at 20° C. In this case, the solid concentration preferably is within a range of 40-60 mass %, in particular, 45-55 mass %. Where the solid concentration is less than 40 mass %, the coating film tends to show sagging more easily. On the other hand, where it exceeds 60 mass %, a tendency to high viscosity or reduction in water dispersibility is observed.

The water-based one package coat of the present invention furthermore preferably has a pH within a range of generally 6.0-8.5, in particular, 6.5-8.0, in respect of the aqueous dispersion stability. The pH measurement in later-appearing Production Examples was done with a pH meter. As the pH meter, for example, F-22 (tradename, Horiba Seisakusho) can be used.

The water-based one package coat of the present invention can be applied by the means known per se, such as air spray, airless spray, rotary atomizing application or the like, for forming top coating film on various coating objects. Static electricity may also be applied in the occasion of application. The applied film thickness can be, as cured film, normally 20-50 μm, preferably 25-45 μm. Curing of the coated film can be effected by heating normally at about 120° C.-about 170° C., preferably at about 130° C.-about 170° C., for around 10-40 minutes. The heating can be effected by the means known per se, for example, drying ovens such as hot air oven, electric oven, infrared ray drying oven and the like.

It is preferred to carry out preheating before the above heating for curing, to volatilize the medium in the paint composition such as water or organic solvent and to dry the film. The preheating is normally performed at temperatures of about 50-about 100° C., for about 3-30 minutes. By this preheating, the solid concentration in the coating film is preferably raised to at least 80 mass %.

### Multilayer Coating Film-Forming Method

With use of the water-based one package coat of the present invention, coating film of excellent performance such as curability, film hardness, acid resistance and scratch resistance, and also finished appearance such as surface smoothness can be formed on coating object. Furthermore, because the water-based one package coat of the invention excels also in dispersion stability of the blocked polyisocyanate compound, it can be widely used as water-based paint. In particular, it is conveniently used as clear paint to form top clear coat.

According to the present invention, therefore, a multilayer coating film-forming method is offered, which comprises successively applying onto a coating object at least one layer of base coat paint and at least one layer of clear coat paint to form a multilayer coating film, characterized by applying the water-based one package coat of the invention as the uppermost layer top clear coat paint.

The coating objects are not particularly limited, while, for example, sheet steel such as cold-rolled sheet steel, zinc-plated sheet steel, zinc alloy-plated sheet steel, stainless steel sheet and tin-plated sheet steel; metal substrates such as aluminum plate and aluminum alloy plate; and various plastic materials are preferred. They may also be bodies of various vehicles such as automobiles, two-wheeled vehicles and container cars formed thereof.

The coating objects may also be metallic surfaces of metal substrates or of car bodies, which have been given a surface treatment such as phosphate treatment, chromate treatment or complex oxide treatment. As the coating object to which the multilayer coating film-forming method of the present invention can be applied, car bodies and parts thereof are particularly preferred.

To these coating objects, undercoating (e.g., cationic electrodeposition coating) can be applied in advance, where necessary, and, depending on the occasion, further coating such as intermediate coating may be applied.

More specifically, for example the following methods a-c can be used as the multilayer coating film-forming method of the present invention, in which the water-based one package coat of the present invention is used as the top clear coat paint:

method a: a multilayer coating film-forming method by 2-coat system, in which base coat paint and top clear coat paint are successively applied onto a coating object to form a multilayer film;

method b: a multilayer coating film-forming method by 3-coat system, in which base coat paint, clear coat paint and top clear coat paint are successively applied onto a coating object to form a multilayer film;

method c: a multilayer coating film-forming method by 3-coat system, in which the first base coat paint, second base coat paint and top clear coat paint are successively applied onto a coating object to form a multilayer film.

Each of multilayer film-forming methods a-c is explained in further details.

In the methods a-c, base coat paint and clear coat paint can be applied by such means as airspray coating, airless spray coating, rotary atomizing coating and the like. Static electricity may be applied in carrying out these methods, where necessary.

In the above method a, per se known base coat paint can be used as the base coat paint, while colored base paint composition used for coating automobile bodies and the like is preferred.

The colored base paint composition may be either organic solvent-based or water-based type, comprising base resin, crosslinking agent and pigment (e.g., coloring pigment, effect pigment and the like). From the viewpoint of low VOC content, water-based paint composition is preferred.

As the base resin, for example, at least one of acrylic resin, vinyl resin, polyester resin, alkyd resin, urethane resin and the like, which have crosslinkable functional groups such as hydroxyl, epoxy, carboxyl, alkoxysilyl or the like groups can be used. As the crosslinking agent, for example, at least one of alkyletherified melanine resin, urea resin, guanamine resin, polyisocyanate compound, blocked polyisocyanate compound, epoxy compound, carboxyl-containing compound and the like can be used. These base resin and crosslinking agent are preferably used at such ratios, based on the combined amount of the two components, that the base resin occupies 50-90 mass % and the crosslinking agent, 10-50 mass %.

The above base coat paint is applied onto a coating object to a thickness of normally about 10-50 μm, in terms of cured coating film. The applied base coat paint is either cured by heating normally at about 100-about 180° C., preferably about 120-about 160° C., for around 10-40 minutes, or not cured but allowed to stand at room temperature for several minutes or preheated at about 40-about 100° C. for around 1-20 minutes.

Then a water-based one package coat of the present invention is applied as the top clear coat paint to a thickness of normally about 20-50 μm in terms of cured coating film, and heated to form a cured multilayer coating film. The heating is preferably performed normally at about 120-about 170° C., preferably about 130-about 170° C., for around 10-40 minutes.

In the above method, the case where the top clear coat paint is applied on uncured base coat film and the two coating films are simultaneously cured is called 2-coat-1-bake system. Whereas, when the base coat paint is applied and cured by heating and thereafter the top clear coat paint is applied and the clear coating film is cured, it is called 2-coat-2-bake system.

In the method b, base coat paint compositions similar to those explained as to the method a can be used as the base coat paint. The clear coat paint is subject to no particular limitation so long as it can form transparent coating film, and for example, paint composition obtained by eliminating the most or all pigment from per se known base coat paints can be used. As the top clear coat paint, a water-based one package coat of the present invention is used. It is also permissible to use a water-based one package coat of the present invention as a clear coat paint.

Similarly to the method a, in the method b a base coat paint is applied onto a coating object, cured by heating or not cured but left to stand at room temperature for several minutes or preheated, and then onto the base coating film a clear coat paint is applied to a thickness of normally about 10-50 μm in terms of cured coating film, followed by curing at normally about 100-about 180° C., preferably about 120-about 160° C., for 10-40 minutes, or by standing at room temperature for several minutes or preheating without the curing step. Successively a water-based one package coat of the present invention is applied as the top clear coat paint, normally to a thickness of about 20-50 μm in terms of cured coating film, and heated similarly to the case of the method a to form a multilayer coating film.

In the above, when the base coat paint is applied but not cured by heating, and onto which the clear coat paint is applied but left uncured and a top clear coat paint is applied thereon, followed by curing the three-layered coating film simultaneously, 3-coat-1-bake system is adopted. Where the base coat is left uncured and simultaneously heated and cured with the clear coat applied thereon, followed by application and curing of the top clear coat, 3-coat-2-bake system is adopted. Furthermore, when the three layers are each heat-cured after its application, 3-coat-3-bake system is adopted.

In the method c, base coat paint compositions similar to those explained as to the method a) can be used as the first base coat paint. As the second base coat paint is applied onto the surface coated with the first base coat paint, normally a low hiding power colored base paint composition as will allow perception of the color tone of the first base coat through the second base coating film is used as the second base coat paint.

Similarly to the method a, in the method c the first base coat paint is applied onto a coating object, cured by heating or not cured but left to stand at room temperature for several minutes or preheated, and then onto the first base coating film the second base coat paint is applied to a thickness of normally about 10-50 μm in terms of cured coating film, followed by curing at normally about 100-about 180° C., preferably about 120-about 160° C., for 10-40 minutes, or by standing at room temperature for several minutes or preheating without the curing step. Successively a water-based one package coat of the present invention is applied as the top clear coat paint, normally to a thickness of about 20-50 μm in terms of cured coating film, and heated similarly to the case of the method a to form a multilayer coating film.

In the above, when the first base coat paint is applied but not cured by heating, and onto which the second base coat paint is applied but left uncured and a top clear coat paint is applied thereon, followed by curing the three-layered coating film simultaneously, 3-coat-1-bake system is adopted. Where the first base coat is left uncured and simultaneously heated and cured with the second base coat applied thereon, followed by application and curing of the top clear coat, 3-coat-2-bake system is adopted. Furthermore, when the three layers are each cured by heating after its application, 3-coat-3-bake system is adopted.

According to the invention, there is also provided a multilayer coating film-forming method which comprises applying a thermosetting water-based paint composition onto a coating object as a base coat paint, applying onto the uncured coated surface a water-based one package coat of the present invention as a clear coat paint, and curing the base coat and clear coat simultaneously. This method corresponds to the above method a, in which a water-based colored base paint composition is used as the base coat paint, and the curing by heating is effected by 2-coat-1-bake system.

### EXAMPLES

Hereinafter the present invention is more specifically explained, referring to working Examples and Comparative Examples, it being understood that the invention is not limited thereto. Hereafter “part” and “%” are invariably based on mass, and thickness of coating film invariably refers to cured coating film thickness.

### Preparation of Acrylic Resin (A)

### Production Example 1

A 4-necked flask equipped with a heating device, stirrer, thermometer and reflux condenser was charged with 30 parts of propylene glycol monopropyl ether, inside temperature of which was then raised to 145° C. under passing nitrogen gas. The nitrogen gas supply was stopped and, as the first stage, 15 parts of styrene, 10 parts of n-butyl acrylate, 18 parts of isobutyl methacrylate, 13 parts of 4-hydroxybutyl acrylate, 12 parts of PLACCEL FA-2, 7 parts of 2-hydroxyethyl methacrylate and 3.0 parts of di-t-butyl peroxide were dropped into the flask over 4 hours. The reaction system was maintained at the same temperature for the following 30 minutes. Further as the second stage, 6 parts of isobutyl methacrylate, 6 parts of 4-hydroxybutyl acrylate, 6 parts of PLACCEL FA-2, 3 parts of 2-hydroxyethyl methacrylate, 4 parts of acrylic acid and 1.0 part of di-t-butyl peroxide were added dropwise over 30 minutes, followed by an hour's aging at the same temperature. Thereafter the solvent was distilled off under reduced pressure until the solid concentration rose to at least 95%. Diluting the residue with 38 parts of methyl ethyl ketone, an acrylic resin (A-1) solution having a solid content of 70% was obtained. Thus obtained acrylic resin (A-1) had a hydroxyl value of 147 mgKOH/g, an acid value of 31 mgKOH/g, a weight-average molecular weight of 10,000, a measured SP value of 10.30 and Tg of 0° C.

### Production Examples 2-15

Using the starting materials as shown in Table 1, acrylic resin (A-2)-(A-15) were obtained in the manner similar to Production Example 1.

Table 1 shows the compositions of the starting materials, solid contents and properties of the acrylic resins (A-1)-(A-15).

TABLE 1

| | | A-1 | A-2 | A-3 | A-4 | A-5 | A-6 | A-7 | A-8 |
|---|---|---|---|---|---|---|---|---|---|
| The First | styrene | 15 | 15 | 15 | 15 | 15 | 15 | 30 | 15 |
| Stage | n-butyl acrylate | 10 | 6 | 14 | | 12.5 | 20 | 10 | 23 |
| | isobutyl methacrylate | 18 | 15 | 20 | 29 | 23.5 | 15 | 3 | 11 |
| | methyl methacrylate | | | | | | | | |
| | PLACCEL FA-2 | 12 | 7 | 10 | 9 | | | 12 | |
| | 4-hydroxybutyl acrylate | 13 | 21 | 10 | 22 | 13 | 15 | 13 | 13 |
| | BLENMER PE-90⁽*⁾ | | | | | 4 | | | |
| | 2-hydroxyethyl methacrylate | 7 | 11 | 6 | | 7 | 10 | 7 | 13 |
| | hydroxypropyl methacrylate | | | | | | | | |
| | acrylic acid | | | | | | | | |
| | di-t-butyl peroxide | 3 | 3 | 3 | 3 | 3 | 3 | 3 | 3 |
| The Second | n-butyl acrylate | | | | | | 5 | | 8 |
| Stage | isobutyl methacrylate | 6 | 7 | 7 | 6 | 7.5 | 4 | 6 | 4 |
| | methyl methacrylate | | | | | | | | |
| | PLACCEL FA-2 | 6 | 3 | 3 | 5 | | | 6 | |
| | 4-hydroxybutyl acrylate | 6 | 8 | 8 | 10 | 6 | 7 | 6 | 5 |
| | BLENMER PE-90⁽*⁾ | | | | | 6 | | | |
| | 2-hydroxyethyl methacrylate | 3 | 3 | 3 | | 3 | 5 | 3 | 4 |
| | hydroxypropyl methacrylate | | | | | | | | |
| | acrylic acid | 4 | 4 | 4 | 4 | 2.5 | 4 | 4 | 4 |
| | d-t-butyl peroxide | 1 | 1 | 1 | 1 | 1 | 1 | 1 | 1 |
| Properties | hydroxyl value (mgKOH/g) | 147 | 190 | 122 | 148 | 146 | 150 | 147 | 143 |
| | use ratio of component (a) | 37 | 39 | 31 | 46 | 29 | 22 | 37 | 18 |
| | (%) | | | | | | | | |
| | hydroxyl value based on | 103 | 129 | 82 | 148 | 103 | 85 | 103 | 70 |
| | component (a) (mgKOH/g) | | | | | | | | |
| | acid value (mgKOH/g) | 31 | 31 | 31 | 31 | 31 | 31 | 31 | 31 |
| | glass transition temp. (° C.) | 0 | 0 | 0 | −2 | 0 | 0 | 5 | −2 |
| | measured SP | 10.30 | 10.52 | 10.17 | 10.19 | 10.08 | 10.07 | 10.42 | 10.01 |
| | solid content (%) | 70 | 70 | 70 | 70 | 70 | 70 | 70 | 70 |

| | | A-9 | A-10 | A-11 | A-12 | A-13 | A-14 | A-15 |
|---|---|---|---|---|---|---|---|---|
| The First | styrene | 15 | 15 | 15 | 15 | 15 | 15 | 15 |
| Stage | n-butyl acrylate | 14 | 8 | 9 | 37 | 9 | 12 | |
| | isobutyl methacrylate | 7 | 12 | | | 28 | 26 | 14 |
| | methyl methacrylate | | | 11 | | | | |
| | PLACCEL FA-2 | 25 | 26 | 26 | | | 10 | 15 |
| | 4-hydroxybutyl acrylate | | 4 | 4 | | | 12 | 31 |
| | BLENMER PE-90⁽*⁾ | | | | | | | |
| | 2-hydroxyethyl methacrylate | 14 | 10 | 10 | 23 | | | |
| | hydroxypropyl methacrylate | | | | | 23 | | |
| | acrylic acid | | | | | | | |
| | di-t-butyl peroxide | 3 | 3 | 3 | 3 | 3 | 3 | 3 |
| The Second | n-butyl acrylate | | | 1 | 10 | | | |
| Stage | isobutyl methacrylate | 3 | 3 | | | 10 | 9 | 6 |
| | methyl methacrylate | | | 2 | | | | |
| | PLACCEL FA-2 | 12 | 11 | 11 | | | 5 | 5 |
| | 4-hydroxybutyl acrylate | | 2 | 2 | | | 7 | 10 |
| | BLENMER PE-90⁽*⁾ | | | | | | | |
| | 2-hydroxyethyl methacrylate | 6 | 5 | 5 | 11 | | | |
| | hydroxypropyl methacrylate | | | | | 11 | | |
| | acrylic acid | 4 | 4 | 4 | 4 | 4 | 4 | 4 |
| | d-t-butyl peroxide | 1 | 1 | 1 | 1 | 1 | 1 | 1 |
| Properties | hydroxyl value (mgKOH/g) | 147 | 148 | 148 | 147 | 147 | 99 | 192 |
| | use ratio of component (a) | 37 | 43 | 43 | 0 | 0 | 34 | 61 |
| | (%) | | | | | | | |
| | hydroxyl value based on | 60 | 84 | 84 | 0 | 0 | 99 | 99 |
| | component (a) (mgKOH/g) | | | | | | | |
| | acid value (mgKOH/g) | 31 | 31 | 31 | 31 | 31 | 31 | 31 |
| | glass transition temp. (° C.) | −2 | 0 | 2 | −2 | −2 | 0 | 0 |
| | measured SP | 10.92 | 10.91 | 11.50 | 10.14 | 9.96 | 10.07 | 10.54 |
| | solid content (%) | 70 | 70 | 70 | 70 | 70 | 70 | 70 |

⁽*⁾BLENMER PE-90: polyethylene glycol monomethacrylate (The degree of polymerization of ethylene glycol was 2, NOF Corporation, corresponding to the component (a))

### Preparation of Blocked Polyisocyanate Compound (B)

### Production Example 16

A 4-necked flask equipped with a stirrer, heating device, cooling device and decompresser was charged with 250 parts of SUMIDUR N3300^{(note 1)} and 125 parts of methyl ethyl ketone, and heated to 30° C. Then 126 parts of 3,5-dimethylpyrazole was gradually added under stirring, consuming 2 hours, and the reaction mixture was reacted under stirring at 30° C., until free isocyanate group became no more detectable by infrared spectrophotometry. After termination of the reaction, a solution of blocked polyisocyanate compound (B-1) having a solid content of 70% was obtained. The resulting blocked polyisocyanate compound (B-1) had a measured SP value of 9.33, NCO content of 14.4% and number-average molecular weight of 1,000. In the present specification, “NCO content” means the amount (%) of NCO groups per 100 mass parts of solid content of the resin. (Note 1) SUMIDUR N3300: tradename, Sumika Bayer Urethane Co., Ltd., hexamethylene diisocyanurate

### Production Example 17

A 4-necked flask equipped with a stirrer, heating device, cooling device and decompresser was charged with 272 parts of hexamethylene diisocyanate and 214 parts of methyl ethyl ketone, which were heated to 60° C. Then 169 parts of methyl ethyl ketoxime was gradually added under stirring, consuming an hour. Thereafter the reaction was continued for 2 hours at 60° C., and then 59 parts of trimethylolpropane was gradually added so as to avoid the temperature rise to 70° C. or higher. The reaction was continued at 60° C. under stirring, until free isocyanate group became no more detectable by infrared spectrophotometry. After termination of the reaction, a solution of blocked polyisocyanate compound (B-2) having a solid content of 70% was obtained. The resulting blocked polyisocyanate compound (B-2) had a measured SP value of 12.19, NCO content of 16.4% and number-average molecular weight of 950.

### Production of Water-Based One Package Coat

### Example 1

The acrylic resin (A-1) solution 88.6 parts and the blocked polyisocyanate (B-1) solution 54.4 parts (NCO/OH=0.8) were stirred and mixed with a rotary blade stirrer (DESPA MH-L, tradename, Asada Iron Works Co. Ltd.). Thereafter under further stirring 1 part of benzoin, 1 part of NEOSTANN U-100^{(note 2)}, 1.4 parts of TINUVIN 1130^{(note 3)} and 1 part of SANOL LS-292^{(note 4)} were successively added by the order stated, and mixed. Then 3.05 parts of dimethylaminoethanol (the amount to make the neutralization equivalent of the carboxyl groups with the amine 1.0) was gradually added and the stirring was continued for further 5 minutes. Then aqueous dispersing was conducted by gradually dropping 101 parts of deionized water into the system to effect uniform dispersion. (note 2) NEOSTANN U-100: tradename, Nitto Kasei Co., dibutyltin dilaurate(note 3) TINUVIN 1130: tradename, Ciba Specialty Chemicals Co., benzotriazole-derived UV absorber(note 4) SANOL LS-292: tradename, Sankyo Lifeteh Co., hindered amine-derived light stabilizer

Thus obtained aqueous dispersion was charged in a 4-necked flask equipped with a stirrer, heater, cooler and decompressor, and desolventing was performed at 50° C. under reduced pressure, to distill off the solvent and water. When the distilled volume reached 60 parts, the reduced pressure desolventing step was terminated, and the residue was cooled to room temperature. More deionized water was added to adjust the viscosity of the product to 30 seconds at 20° C., with Ford cup viscosimeter No. 4, and a water-based one package coat No. 1 was obtained. The solid content of this water-based one package coat No. 1 was 50%, and the average particle size was 220 nm.

### Examples 2-13 and Comparative Examples 1-11

Using the starting materials as shown in Tables 2 and 3, water-based one package coat Nos. 2-24 were obtained in the manner similar to Example 1. The particulars of the blocked polyisocyanate compound (B-3)^{(note 5)} and NEOSTANN U-600^{(note 6)} in the Tables 2 and 3 are as follows: (note 5) blocked polyisocyanate compound (B-3): TPA-B80E (tradename, Asahi Kasei Chemicals Co., isocyanurate compound of hexamethylene diisocyanate whose isocyanate groups are blocked with methyl ethyl ketoxime; solid content, 80%; NCO content, 15.6%). Its measured SP value was 11.45.(note 6) NEOSTANN U-600: tradename, Nitto Kasei Co., a solution of bismuth trioctylate (effective component, 57%)

After viscosity adjustment, each of the water-based one package coat was measured of its solid content, VOC content and average particle size, and tested of storage stability by the following methods. The paint compositions made in Comparative Examples 4, 9 and 10 (water-based one package coat Nos. 17, 22 and 23) showed poor water dispersibility and their aqueous dispersions could not be obtained, rendering their evaluation impossible.

Solid content of the paint composition (%): About 2 g of each water-based one package coat after the viscosity adjustment was measured out onto an aluminum dish of 5 cm in diameter, fully spread over the whole dish, dried at 110° C. for an hour, and the solid content (%) was calculated from the initial weight and the weight after the drying.

VOC content (g/l): VOC content of each water-based one package clear coat after the viscosity adjustment was calculated from its specific gravity (as measured by specific gravity cup method following JIS K-5400 4.6.2), water content (measured with automatic water content measurement device, KF-100, tradename, Karl Fischer's method, Mitsubishi Chemicals Co.) and solid content of the coat, according to the following equation (1):

VOC content(g/l)={[100−(S+W)]×ρ}/[100−(w×ρ)] (1)

In the equation (1), S stands for the solid content (%) of the coat, W stands for the water content (%) of the coat, and ρ, specific gravity (g/l) of the coat.

Average particle size (nm) of the coat: Each water-based one package coat after the viscosity adjustment was dispersed with deionized water, and its average particle size (nm) was measured at 20° C. with COULTER N4 Model (tradename, Beckman Coulter, Inc., submicron particle size distribution measuring device).

Storage stability: Each water-based one package coat after the viscosity adjustment was stored at 40° C. for 10 days, and the condition of the coat was evaluated according to the following criteria:
◯: no viscosity change or sedimentation observed, good
◯Δ: minor sedimentation observed but restored upon stirring
Δ: minor sedimentation observed, not restorable even by stirring
x: phase separation occurred due to sedimentation, not restorable by stirring

Tables 2 and 3 show the components and composition of each water-based one package coat (solid content by part), neutralization equivalent, NCO/OH ratio, acrylic resin properties, SP value, SP difference, solid content of the coat, VOC content, average particle size of the coat and result of the storage stability evaluation.

### Preparation of Test Panels 1

Test panels were prepared using each of the water-based one package coat Nos. 1-24 as obtained in Examples 1-13 and Comparative Examples 1-11. (As for Comparative Examples 4, 9 and 10 (water-based one package coat Nos. 17, 22 and 23), no paint composition could be prepared and hence the test panels could not be made).

A cold-rolled and zinc phosphated (PALBOND #3020, tradename, Nippon Parkerizing Co.) steel sheet was electrocoated with a cationic electrocoating paint (ELECRON GT-10, tradename, Kansai Patent Co.) to a film thickness of 20 μm, followed by curing by heating at 170° C. for 30 minutes to form an electrocoating film. Onto the electrocoating film, an organic solvent-based intermediate paint (AMILAC TP-65-2, tradename, Kansai Paint Co., polyester resin-melamine resin-type intermediate paint for automobiles) was air spray coated to a film thickness of 35 μm, left to stand at room temperature for 7 minutes, and cured by heating at 140° C. for 20 minutes to form an intermediate coating film.

Onto this intermediate coating film, an acrylic resin-melamine resin type water-based base coat paint for automobiles (WBC713T #1E7, tradename, Kansai Paint Co.) was applied to a film thickness of 15 μm, left to stand at room temperature for 5 minutes and preheated at 80° C. for 10 minutes. Onto this uncured base coat, water-based one package coat Nos. 1-24 as obtained in the Examples and Comparative Examples were applied each to a film thickness of 35 μm, left to stand at room temperature for 10 minutes, preheated at 60° C. for 10 minutes, and heated at 140° C. for 20 minutes so as to cure the two coating films concurrently, to provide the test panels.

The test panels as obtained in the above were given the following performance tests.

Coated surface smoothness: Smoothness of the coated film surface was measured with Wave Scan (tradename, BYK Gardner Co.). The Wave Scan can measure Long Wave value (LW) and Short Wave value (SW).

Long Wave value is an index of amplitude of surface roughness of the wavelength ranging 1.2-12 mm, and can evaluate large amplitude such as of, e.g., orange peel of coating film surface. Short Wave value is an index of amplitude of surface roughness of the wavelength ranging 0.3-1.2 mm, and can evaluate small amplitude of fine structure of coating film surface.

As to both of the Wave Scan values, less measured values indicate higher smoothness of the coating film surface.

Luster: Luster was evaluated by visual observation:

◯: favorable

Δ: less favorable

x: inferior.

Acid resistance: Onto the coated surface of each test panel, 0.5 ml of 40% aqueous sulfuric acid solution was dropped, and heated at 80° C. for 30 minutes with Gradient Oven (tradename, BYK Gardner Co.). The surface was then washed with water, and the condition of the coated surface was evaluated according to the following criteria:
◯: no change in appearance or corrosion of the coating film observed, good
◯Δ: no change in appearance but slight corrosion of the coating film observed
Δ: appearance change and minor corrosion of the coating film observed
x: heavy appearance change and corrosion of the coating film observed.

### Preparation of Test Panels 2 (Resistance to Yellowing by Overbaking)

Up to the formation of the electrocoating film, the steps for the preparation of test panels 1 were followed. Onto the electrocoating film, a water-based intermediate paint (WP305T #062 First Base, tradename, Kansai Paint Co., a polyester resin-melamine resin water-based intermediate paint for automobiles, having L value for degree of whiteness based on CIE color-matching function of 85) was air spray coated to a film thickness of 35 μm, left at room temperature for 5 minutes, preheated at 80° C. for 10 minutes, and cured by heating at 150° C. for 30 minutes to form the intermediate coating film.

Onto the intermediate coating film, a water-based base coat paint (WBC 713T #062 Second Base, tradename, Kansai Paint Co., an acrylic resin-melamine resin mica-base coat paint for automobiles) was applied to a thickness of 15 μm, left at room temperature for 5 minutes and preheated at 80° C. for 10 minutes. Onto this uncured mica base coating film, those water-based one package clear coat Nos. 1-24 as obtained in the above Examples and Comparative Examples were applied each to a film thickness of 40 μm, left at room temperature for 10 minutes, preheated at 80° C. for 10 minutes, and the two coating films were concurrently cured by heating at 140° C. for 30 minutes, to provide the test panels.

A part each of the test panels were cut off to provide standard panels. The remaining parts of the test panels were further heated at 160° C. for 50 minutes.

By measuring Δb values based on CIE color-matching function of the test panels after the 50 minutes' heating at 160° C. to the standard panels, the samples' resistance to yellowing by overbaking was evaluated. Less Δb values indicate higher resistance to yellowing by overbaking. The Δb value measurement was carried out with Color Guide 45/0 (tradename, BYK Gardner Co.).

### Preparation of Test Panels 3 (Adherability to Non-Sand Recoat)

Test panels were prepared by the, same steps to those for preparing the above test panels 1, except that the last heating condition of the two coating films of the base coat and clear coat was changed to an overbaking at 160° C. for 30 minutes. On the coated surfaces of these overbaked test panels, once again the same base coat paint and the water-based one package clear coat which were used in the preparation of test panels 1 were applied. Changing the heating condition of the two coating films of the base coat and clear coat to 30 minutes' heating at 130° C. and otherwise repeating the paint application, preheating and heat-curing steps for preparing the test panels 1, test panels for evaluation of non-sand recoat adherability were obtained.

Each surface of the test panels for non-sand recoat adherability evaluation was cross-cut with a cutter knife to the depth reaching the substrate, to mark 100 2 mm×2 mm squares. Onto the 100 squares a cellophane tape was stuck and then rapidly peeled off. The non-sand recoat adherability was evaluated according to the number of squares on which the coating film remained intact. The evaluation criteria were as follows:
◯: remaining square number was 100,
◯Δ: remaining square number was not less than 90 but less than 100,
Δ: remaining number of squares was not less than 50 but less than 90,
x: remaining number of squares was less than 50.

Table 2 and 3 concurrently show the results of above evaluation of coated surface smoothness, luster, acid resistance, resistance to yellowing due to overbaking and non-sand recoat adherability.

TABLE 2

| | | Example | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| Water-based one | | 1 | 2 | 3 | 4 | 5 | 6 | 7 | 8 | 9 | 10 | 11 | 12 | 13 |
| package coat No. | | | | | | | | | | | | | | |
| Acrylic | (A-1) | 62 | | | | | | 62 | 69 | 62 | | 54 | 62 | 62 |
| resin | (A-2) | | 56 | | | | | | | | | | | |
| | (A-3) | | | 66 | | | | | | | | | | |
| | (A-4) | | | | 62 | | | | | | | | | |
| | (A-5) | | | | | 62 | | | | | | | | |
| | (A-6) | | | | | | 62 | | | | | | | |
| | (A-7) | | | | | | | | | | 76 | | | |
| | (A-8) | | | | | | | | | | | | | |
| | (A-9) | | | | | | | | | | | | | |
| | (A-10) | | | | | | | | | | | | | |
| | (A-11) | | | | | | | | | | | | | |
| | (A-12) | | | | | | | | | | | | | |
| | (A-13) | | | | | | | | | | | | | |
| | (A-14) | | | | | | | | | | | | | |
| | (A-15) | | | | | | | | | | | | | |
| Blocked | (B-1) | 38 | 44 | 34 | 38 | 38 | 38 | 38 | 31 | 38 | 24 | 46 | 38 | 38 |
| poly- | (B-2) | | | | | | | | | | | | | |
| isocyanate | (B-3) | | | | | | | | | | | | | |
| compound | | | | | | | | | | | | | | |
| Benzoin | | 1 | 1 | 1 | 1 | 1 | 1 | 1 | 1 | 1 | 1 | 1 | 1 | 1 |
| NEOSTANN | | 1.0 | 1.0 | 1.0 | 1.0 | 1.0 | 1.0 | 1.0 | 1.0 | | 1.0 | 1.0 | 1.0 | |
| U-100^{(note 2)} | | | | | | | | | | | | | | |
| NEOSTANN | | | | | | | | | | 1.5 | | | | |
| U-600^{(note 6)} | | | | | | | | | | | | | | |
| TINUVIN 1130^{(note 3)} | | 1.4 | 1.4 | 1.4 | 1.4 | 1.4 | 1.4 | 1.4 | 1.4 | 1.4 | 1.4 | 1.4 | 1.4 | 1.4 |
| SANOL S-292^{(note 4)} | | 1 | 1 | 1 | 1 | 1 | 1 | 1 | 1 | 1 | 1 | 1 | 1 | 1 |
| Neutralization | | 1.0 | 1.0 | 1.0 | 1.0 | 1.0 | 1.0 | 0.6 | 1.0 | 1.0 | 1.0 | 1.0 | 0.5 | 1.0 |
| equivalent(*) | | | | | | | | | | | | | | |
| NCO/OH ratio | | 0.8 | 0.8 | 0.8 | 0.8 | 0.8 | 0.8 | 0.8 | 0.6 | 0.8 | 0.4 | 1.1 | 0.8 | 0.8 |
| Properties | hydroxyl | 147 | 190 | 122 | 148 | 146 | 150 | 147 | 147 | 147 | 147 | 147 | 147 | 147 |
| of acrylic | value | | | | | | | | | | | | | |
| resin | (mgKOH/g) | | | | | | | | | | | | | |
| | use ratio of | 37 | 39 | 31 | 46 | 29 | 22 | 37 | 37 | 37 | 37 | 37 | 37 | 37 |
| | component | | | | | | | | | | | | | |
| | (a) (%) | | | | | | | | | | | | | |
| SP | SP value; | 10.30 | 10.52 | 10.17 | 10.19 | 10.08 | 10.07 | 10.30 | 10.30 | 10.30 | 10.42 | 10.30 | 10.30 | 10.30 |
| values | SP1 | | | | | | | | | | | | | |
| | SP value; | 9.33 | 9.33 | 9.33 | 9.33 | 9.33 | 9.33 | 9.33 | 9.33 | 9.33 | 9.33 | 9.33 | 9.33 | 9.33 |
| | SP2 | | | | | | | | | | | | | |
| SP | ΔSP = | 0.97 | 1.19 | 0.84 | 0.88 | 0.75 | 0.74 | 0.97 | 0.97 | 0.97 | 1.09 | 0.97 | 0.97 | 0.97 |
| difference | SP1 − SP2 | | | | | | | | | | | | | |
| (ΔSP) | | | | | | | | | | | | | | |
| Paint | solid | 50 | 50 | 50 | 50 | 50 | 50 | 50 | 50 | 50 | 49 | 50 | 48 | 51 |
| properties | content (%) | | | | | | | | | | | | | |
| | VOC | 57 | 57 | 57 | 57 | 57 | 57 | 56 | 58 | 57 | 59 | 56 | 50 | 57 |
| | content (g/l) | | | | | | | | | | | | | |
| | average | 220 | 260 | 190 | 210 | 220 | 230 | 390 | 180 | 240 | 180 | 250 | 600 | 210 |
| | particle | | | | | | | | | | | | | |
| | size (nm) | | | | | | | | | | | | | |
| Storage stability | | ◯ | ◯ | ◯ | ◯ | ◯ | ◯ | ◯ | ◯ | ◯ | ◯ | ◯ | ◯Δ | ◯ |
| Coated | LW | 5 | 6.2 | 5.5 | 5.3 | 5.2 | 5.8 | 6.8 | 5.5 | 5.4 | 6.5 | 7.2 | 9.5 | 6.6 |
| surface | SW | 8.5 | 8.8 | 9.1 | 8 | 8.5 | 9.1 | 8.5 | 8.5 | 8.5 | 9.1 | 9 | 9.5 | 8.5 |
| smooth- | | | | | | | | | | | | | | |
| ness | | | | | | | | | | | | | | |

| | | | | | | | | | | | | | |
|---|---|---|---|---|---|---|---|---|---|---|---|---|---|
| Luster | ◯ | ◯ | ◯ | ◯ | ◯ | ◯ | ◯ | ◯ | ◯ | ◯ | ◯ | ◯ | ◯ |
| Acid resistance | ◯ | ◯ | ◯ | ◯ | ◯ | ◯ | ◯ | ◯ | ◯ | ◯Δ | ◯ | ◯ | ◯Δ |
| Resistance to yellowing | 1.00 | 0.95 | 1.03 | 0.98 | 1.08 | 1.05 | 1.05 | 0.95 | 1.05 | 0.85 | 1.20 | 1.15 | 1.10 |
| due to overbaking (Δb) | | | | | | | | | | | | | |
| Non-sand recoat | ◯ | ◯ | ◯ | ◯ | ◯ | ◯ | ◯ | ◯ | ◯ | ◯ | ◯Δ | ◯ | ◯ |
| adherability | | | | | | | | | | | | | |

(*)Neutralization equivalent: Neutralization was effected with dimethylaminoethanol.

TABLE 3

| | | Comparatice Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Water-based one package coat No. | | 14 | 15 | 16 | 17 | 18 | 19 | 20 | 21 | 22 | 23 | 24 |
| Acrylic resin | (A-1) | | | | | | | | 64 | 65 | | |
| | (A-2) | | | | | | | | | | | |
| | (A-3) | | | | | | | | | | | |
| | (A-4) | | | | | | | | | | | |
| | (A-5) | | | | | | | | | | | |
| | (A-6) | | | | | | | | | | | |
| | (A-7) | | | | | | | | | | | |
| | (A-8) | 62 | | | | | | | | | | |
| | (A-9) | | 62 | | | | | | | | | |
| | (A-10) | | | 62 | | | | | | | | |
| | (A-11) | | | | 62 | | | | | | 62 | |
| | (A-12) | | | | | 62 | | | | | | |
| | (A-13) | | | | | | 62 | | | | | |
| | (A-14) | | | | | | | 71 | | | | |
| | (A-15) | | | | | | | | | | | 56 |
| Blocked | (B-1) | 38 | 38 | 38 | 38 | 38 | 38 | 29 | | | | 44 |
| polyisocyanate | (B-2) | | | | | | | | | 35 | | |
| compound | (B-3) | | | | | | | | 36 | | 38 | |

| | | | | | | | | | | | |
|---|---|---|---|---|---|---|---|---|---|---|---|
| Benzoin | 1 | 1 | 1 | 1 | 1 | 1 | 1 | 1 | 1 | 1 | 1 |
| NEOSTANN U-100^{(note 2)} | 1.0 | 1.0 | 1.0 | 1.0 | 1.0 | 1.0 | 1.0 | 1.0 | 1.0 | 1.0 | 1.0 |
| NEOSTANN U-600^{(note 6)} | | | | | | | | | | | |
| TINUVIN 1130^{(note 3)} | 1.4 | 1.4 | 1.4 | 1.4 | 1.4 | 1.4 | 1.4 | 1.4 | 1.4 | 1.4 | 1.4 |
| SANOL S-292^{(note 4)} | 1 | 1 | 1 | 1 | 1 | 1 | 1 | 1 | 1 | 1 | 1 |

| | | Comparative Example | | | | | | | | | | |
|---|---|---|---|---|---|---|---|---|---|---|---|---|
| | | 14 | 15 | 16 | 17 | 18 | 19 | 20 | 21 | 22 | 23 | 24 |
| Neutralization equivalent(*) | | 1.0 | 1.0 | 1.0 | 1.0 | 1.0 | 1.0 | 1.0 | 1.0 | 1.0 | 1.0 | 1.0 |
| NCO/OH ratio | | 0.8 | 0.8 | 0.8 | 0.8 | 0.8 | 0.8 | 0.8 | 0.8 | 0.8 | 0.8 | 0.8 |
| Properties of | hydroxyl value (mgKOH/g) | 143 | 148 | 148 | 148 | 147 | 147 | 99 | 147 | 147 | 148 | 192 |
| acrylic resin | use ratio of component (a) | 18 | 37 | 43 | 43 | 0 | 0 | 34 | 37 | 37 | 43 | 61 |
| | (%) | | | | | | | | | | | |
| SP values | SP values; SP1 | 10.01 | 10.92 | 10.91 | 11.50 | 10.14 | 9.96 | 10.07 | 10.30 | 10.30 | 11.50 | 10.54 |
| | SP values; SP2 | 9.33 | 9.33 | 9.33 | 9.33 | 9.33 | 9.33 | 9.33 | 11.45 | 12.19 | 11.45 | 9.33 |
| SP difference | ΔSP = SP1 − SP2 | 0.68 | 1.59 | 1.58 | 2.17 | 0.81 | 0.63 | 0.74 | −1.15 | −1.89 | 0.05 | 1.21 |
| (ΔSP) | | | | | | | | | | | | |
| Paint | solid content (%) | 50 | 52 | 53 | | 50 | 51 | 51 | 52 | | | 51 |
| properties | VOC content (g/l) | 66 | 66 | 66 | | 66 | 60 | 74 | 67 | | | 63 |
| | average particle size (nm) | 190 | 620 | 590 | | 190 | 200 | 180 | 600 | | | 280 |
| Storage stability | | ◯ | X | X | | ◯ | ◯ | ◯ | X | | | ◯ |
| Coated | LW | 5.8 | 10.5 | 10.8 | | 6.3 | 6.5 | 5.8 | 12 | | | 10.9 |
| surface | SW | 11.5 | 16.7 | 17.2 | | 12 | 13 | 9.5 | 19.2 | | | 18.2 |
| smoothness | | | | | | | | | | | | |

| | | | | | | | | |
|---|---|---|---|---|---|---|---|---|
| Luster | ◯ | Δ | Δ | ◯ | ◯ | ◯ | X | ◯ |
| Acid resistance | Δ | Δ | Δ | Δ | X | X | X | X |
| Resistance to yellowing due to overbaking | 1.05 | 1.10 | 1.05 | 1.00 | 1.03 | 0.88 | 2.58 | 1.10 |
| (Δb) | | | | | | | | |
| Non-sand recoat adherability | Δ | Δ | ◯ | X | X | X | Δ | ◯ |

(*)Neutralization equivalent: Neutralization was effected with dimethylaminoethanol.

1. Water-based one package coat which is a paint composition comprising
(1) an acrylic resin (A) obtained through copolymerization of
(a) 20-60 mass % of at least one hydroxyl-containing (meth)acrylic acid ester represented by the following formula (I): 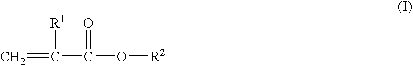
in which
R¹ stands for hydrogen or methyl, and
R² stands for at least C₄ primary hydroxyalkyl, at least C₄ primary hydroxypolyoxyalkylene or an organic substituent of the following formula (II): 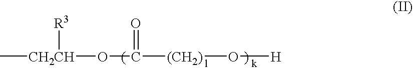
in which R³ stands for hydrogen or methyl, 1 is an integer of 2-5, and k is an integer of 1-7;
(b) 0.7-15 mass % of at least one vinyl monomer containing carboxyl group, sulfonic acid group or phosphoric acid group; and
(c) 25-79.3 mass % of at least one other copolymerizable vinyl monomer; said resin (A) having a hydroxyl value of 110-200 mgKOH/g and an acid value of 5-50 mgKOH/g:
and
(2) at least one blocked polyisocyanate compound (B),
and in that the solubility parameter (SP1) of the acrylic resin (A) is 9.30-11.20, that (SP2) of the blocked polyisocyanate compound (B) is 9.00-11.50, and the difference ΔSP between the solubility parameter (SP1) of the acrylic resin (A) and the solubility parameter (SP2) of the blocked polyisocyanate compound (B) (ΔSP=(SP1)−(SP2)) is within a range of from −0.80 to 1.50,
the blocked polyisocyanate compound (B) comprises an azole compound-blocked polyisocyanate compound, and
the paint composition further contains organotin compound and/or bismuth compound as the catalyst.

2. The water-based one package coat according to claim 1, in which the acrylic resin (A) has a hydroxy value within a range of 120-180 mgKOH/g and an acid value within a range of 10-40 mgKOH/g.

3. The water-based one package coat according to claim 1, in which the solubility parameter (SP1) of the acrylic resin (A) is 9.50-11.00.

4. The water-based one package coat according to claim 1, in which the solubility parameter (SP2) of the blocked polyisocyanate compound (B) is 9.20-10.50.

5. The water-based one package coat according to claim 1, in which the difference ΔSP between the solubility parameter (SP1) of the acrylic resin (A) and that (SP2) of the blocked polyisocyanate compound (B) (ΔSP=(SP1)−(SP2)) is within a range of 0.50-1.20.

6. The water-based one package coat according to claim 1, in which the blocked polyisocyanate compound (B) comprises 3,5-dimethylpyrazole-blocked polyisocyanate compound.

7. The water-based one package coat according to claim 1, in which the equivalent ratio (NCO/OH) of isocyanate group in the blocked polyisocyanate compound (B) to hydroxyl group in the acrylic resin (A) is 0.5-1.0.

8. The water-based one package coat according to claim 1, which contains 0.01-10 mass parts of organotin compound and/or bismuth compound per 100 mass parts of combined solid content of the acrylic resin (A) and blocked polyisocyanate compound (B).

9. The water-based one package coat according to claim 1, which further contains hindered amine light stabilizer.

10. The water-based one package coat according to claim 1, in which the dispersed particles present in the paint composition have average particle diameter of 100-500 nm.

11. The water-based one package coat according to claim 1 having a mass concentration of the solid content of 40-60% and VOC content of 0-300 g/l.

12. A multilayer coating film-forming method comprising successively applying onto a coating object at least one layer of base coat paint and then at least one layer of clear coat paint, the clear coat paint being the water-based one package coat which is described in claim 1.

13. A multilayer coating film-forming method comprising applying onto a coating object a thermosetting water-based paint composition as the base coat paint, applying onto the uncured coated surface the water-based one package coat which is described in claim 1 as the clear coat paint, and curing the base coat and clear coat simultaneously.

14. Articles coated by the method according to claim 12.

15. Articles coated by the method according to claim 13.
